(19) United States
(12) Patent Application Publication
(10) Pub. No.: US 2026/0082106 A1
(43) Pub. Date: Mar. 19, 2026

(54) DYNAMIC REPLAY OF AV CONTENT BASED ON LACK OF USER UNDERSTANDING

(71) Applicant: Sony Group Corporation, TOKYO (JP)

(72) Inventor: Brant L. Candelore, San Diego, CA (US)

(21) Appl. No.: 18/886,793

(22) Filed: Sep. 16, 2024

(51) Int. Cl. H04N 21/472; G10L 15/22; G10L 15/25; G10L 21/0208

(52) U.S. Cl. CPC H04N 21/47217; G10L 15/22; G10L 15/25; G10L 21/0208

(57) ABSTRACT

To aid a user's understanding of what was said in audio video (AV) content, devices and methods are disclosed to digitally and dynamically replay the AV content in a way that is different from just rewinding the AV content and playing it out again. Accordingly, in one aspect an apparatus may include a processor system and storage accessible to the processor system. The storage may include instructions executable by the processor system to present the AV content, and to receive a command to replay a portion of the AV content. Responsive to receipt of the command, the instructions may also be executable to replay the portion of the AV content from a previous playback position and to also take at least one other action to aid a user's understanding of spoken words from the AV content.

### FIELD

The disclosure below relates to technically inventive, non-routine solutions that are necessarily rooted in computer technology and that produce concrete technical improvements. In particular, this disclosure relates to selective, dynamic replay of audio video (AV) content to aid a user's understanding of what was said in the AV content.

### BACKGROUND

As recognized herein, there may be instances where a user is watching a video and misses part of what was said in the video. As also recognized herein, the user might try to rewind the video to hear the words again, but often times the words are still unintelligible, leaving the user without any understanding as to what was said yet again. Current electronics devices therefore fail to remedy the initial problem through their own technical offerings. There are therefore currently no adequate solutions to the foregoing computer-related, technological problems.

### SUMMARY

Accordingly, in one aspect an apparatus includes a processor system and storage accessible to the processor system. The storage includes instructions executable by the processor system to present audio video (AV) content at a device and to receive a command to replay a portion of the AV content. Responsive to receipt of the command, the instructions are executable to replay the portion of the AV content from a previous playback position and also take at least one other action to aid a user's understanding of spoken words from the AV content.

In one example implementation, the at least one other action may include presenting text corresponding to spoken words from audio of the AV content. The text corresponding to the spoken words may be established by closed captioning text from metadata of the AV content. Additionally or alternatively, the instructions may be executable to identify the text corresponding to the spoken words by executing speech recognition on the audio of the AV content, and to execute a lip reading model using video of the AV content to adjust the text according to an output from the lip reading model. The adjusted text may then establish closed captioning text for the apparatus to present to the viewer, with the output itself indicating one or more spoken words inferred by the lip reading model.

In addition to or in lieu of that, the at least one other action may include slowing down presentation of audio of the AV content from a real-time playback speed to a slower playback speed.

Additionally or alternatively, the at least one other action may include boosting the volume of audio of the AV content in frequencies that are in one or more human voice frequency ranges. The boosting may be from a first volume level at which audio in the one or more human voice frequency ranges was presented prior to receipt of the command to a second volume level that is higher than the first volume level. If desired, the instructions may also be executable to reduce the volume of audio in frequencies of the audio that are outside the one or more human voice frequency ranges.

Still further, if desired the at least one other action may include the use of a deep neural network to use sound patterns and neural network processing to replace incoming sound with processed outgoing sound to enhanced speech clarity.

Additionally, in some example embodiments the AV content may be played back from a first position different from the previous position. Here, the instructions may be executable to, in the same presentation instance and responsive to reaching the first position again during playback of the AV content, stop taking the at least one other action in relation to presentation of the AV content from the previous playback position.

In another aspect, a method includes presenting audio video (AV) content at a device and receiving a command to replay a portion of the AV content. The method then includes, responsive to receiving the command, replaying the portion of the AV content from a previous playback position and also taking at least one other action related to presentation of the AV content from the previous playback position.

Thus, in certain examples the method may include receiving input from a microphone and, based on the input, identifying speech from a user that indicates a lack of understanding about spoken words from audio of the AV content. Based on identifying the speech, the method then includes taking the at least one other action related to presentation of the AV content from the previous playback position.

Also in certain examples, the command itself may be a command to revert to playback of the AV content a preset number of time increments before a current playback position.

In various example implementations, the at least one other action may include presenting text corresponding to spoken words from audio of the AV content. In one particular example, the method may even include identifying the text corresponding to the spoken words by executing speech recognition on the audio of the AV content and then executing a lip reading model using video of the AV content to adjust the text according to an output from the lip reading model. The output may indicate a spoken word inferred by the lip reading model.

In addition to or in lieu of that, the at least one other action may include slowing down presentation of the AV content from a real-time playback speed to a slower playback speed. Still further, the at least one other action may include boosting the volume of audio of the AV content in frequencies that are in one or more human voice frequency ranges, with the boosting being from a first volume level at which audio in the one or more human voice frequency ranges was presented prior to receipt of the command to a second volume level that is higher than the first volume level. The one or more human voice frequency ranges may include a frequency range of 90 Hz to 155 Hz for adult makes and/or a frequency range of 165 Hz to 255 Hz for adult females.

Also, if desired, the at least one other action may include using neural network processing to separate speech from background noise, and to output the processed speech.

In still another aspect, at least one computer readable storage medium (CRSM) that is not a transitory signal includes instructions executable by a processor system to present audio video (AV) content at a device and to receive a command to replay a portion of the AV content. The instructions are also executable to, responsive to receipt of the command, replay the portion of the AV content from a previous playback position and also take at least one other action related to presentation of the AV content from the previous playback position.

Thus, in one example instance the at least one other action may include adjusting text that was identified using a speech-to-text algorithm, with the text adjusted based on an output from a lip reading model that processed video of the AV content to provide the output. Here the at least one action may further include presenting the adjusted text on a display during the replay of the portion of the AV content from the previous playback position.

The details of the present disclosure, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example computing system consistent with present principles;

FIG. 2 shows an illustration of a user watching AV content and providing input through an audible exclamation consistent with present principles;

FIG. 3 shows an example graphical user interface (GUI) on which different types of closed captioning/subtitle text may be presented consistent with present principles;

FIG. 4 illustrates example logic in example flow chart format that may be executed by an apparatus/processor system consistent with present principles;

FIG. 5 shows example artificial intelligence (AI) model architecture that may be implemented consistent with present principles; and

FIG. 6 shows an example settings GUI that may be presented on a display to configure one or more settings of an application and/or apparatus to operate consistent with present principles.

### DETAILED DESCRIPTION

Among other things, disclosed below are methods and apparatuses to implement a skip-back function for a user watching a TV show (or other AV content) when something is not heard correctly by the user and the user/listener/viewer is left wondering what was said. The AV content might be a live TV show, a recorded show saved to DVR or provided by an over-the-top streaming service, a live or previously-recorded video streamed over the Internet, etc.

Accordingly, in one example implementation the viewer might press a button on the TV's remote control to skip back 20 or 30 seconds. If not already turned on, the show's closed captioning may then be turned on for the duration of the skip back time. And if pre-determined closed captioning is not available, speech-to-text may be implemented to dynamically generate closed captioning text. Additionally, the audio volume can be bumped up with the speech frequencies boosted temporarily as well. The predetermined closed captioning and the speech-to-text result might even be displayed side by side for a moment. Also based on the viewer pressing the button on the remote control to skip back 20 or 30 seconds, during the skip back time, the device may slow down the presentation of the audio and video into slow-motion to allow more time for the viewer to listen to what was being said to gain additional comprehension. This can be particularly useful when, for example, speech is not understood correctly because the person speaking in the AV content is mumbling, not articulating, and/or speaking too quickly for the viewer.

Also in one example embodiment as incorporated into a television (or other client device) to be activated responsive to a rewind/replay event, deep neural networks such as those by Phonak may be used to not only enhance voice frequencies but also to use sound patterns and neural network processing to separate speech from background noise in order to replace incoming sound with processed outgoing sound (e.g., with enhanced speech clarity compared to the input sound).

With the foregoing in mind, it is to be generally understood that this disclosure relates to aspects of consumer electronics (CE) devices and other types of client devices and servers. Thus, devices herein may include server and client components which may be connected over a network such that data may be exchanged between the client and server components. The client components may include one or more computing devices including mobile smart phones, smart watches and other mobile devices, wearable devices, game consoles, extended reality (XR) headsets such as virtual reality (VR) headsets and augmented reality (AR) headsets, display devices such as televisions (e.g., smart TVs, Internet-enabled TVs), personal computers such as laptops, desktop, and tablet computers, and still other types of devices. These client devices may operate with a variety of operating environments. For example, a client device consistent with present principles may employ, as examples, Linux and Unix operating systems, operating systems from Microsoft, or operating systems from Apple or Google. These operating environments may be used to execute one or more browsing programs, such as a browser made by Microsoft, Apple, Google, or Mozilla. The operating environments may also be used to execute other Internet-networked dedicated mobile applications that can access websites hosted by the Internet servers over a network such as the Internet, a local intranet, or a virtual private network.

Servers and/or gateways may be used that may include one or more processors executing instructions that configure the servers to receive and transmit data over a network such as the Internet. Or a client and server can be connected over a local intranet or a virtual private network. A server or controller may be instantiated by a personal computer, mobile device, rack or blade server, etc.

As indicated above, information may be exchanged over a network between client devices and servers. To this end and for security, servers and/or clients can include firewalls, load balancers, temporary storages, and proxies, and other network infrastructure for reliability and security.

As used herein, instructions may refer to computer-implemented steps for processing information in the system. Instructions can be implemented in software, firmware or hardware, or combinations thereof and include any type of programmed steps undertaken by components of the system.

A processor may be any single-or multi-chip processor that can execute logic by means of various lines such as address lines, data lines, and control lines and registers and shift registers. Moreover, any logical blocks, modules, and circuits described below can be implemented or performed with a processor/processor system such as a central processing unit (CPU), a digital signal processor (DSP), a field programmable gate array (FPGA) or other programmable logic device, an application specific integrated circuit (ASIC), discrete gate or transistor logic, discrete hardware components, or any combination thereof designed to perform the functions described herein. A processor can be implemented by a controller or state machine or a combination of computing devices.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

The functions and methods described below, when implemented in software, can be written in an appropriate language such as but not limited to C# or C++, and can be stored on or transmitted from a computer-readable storage medium such as a hard disk drive (HDD) or solid state drive (SSD), random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

In an example, a processor/processor system can access information over its input lines from data storage, such as a computer readable storage medium as referenced above, and/or the processor system can access information wirelessly from an Internet server by activating a wireless transceiver to send and receive data. Data typically is converted from analog signals to digital by circuitry between the antenna and the registers of the processor system when being received and from digital to analog when being transmitted. The processor system then processes the data through its shift registers to output calculated data on output lines, for presentation of the calculated data on the device, etc.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

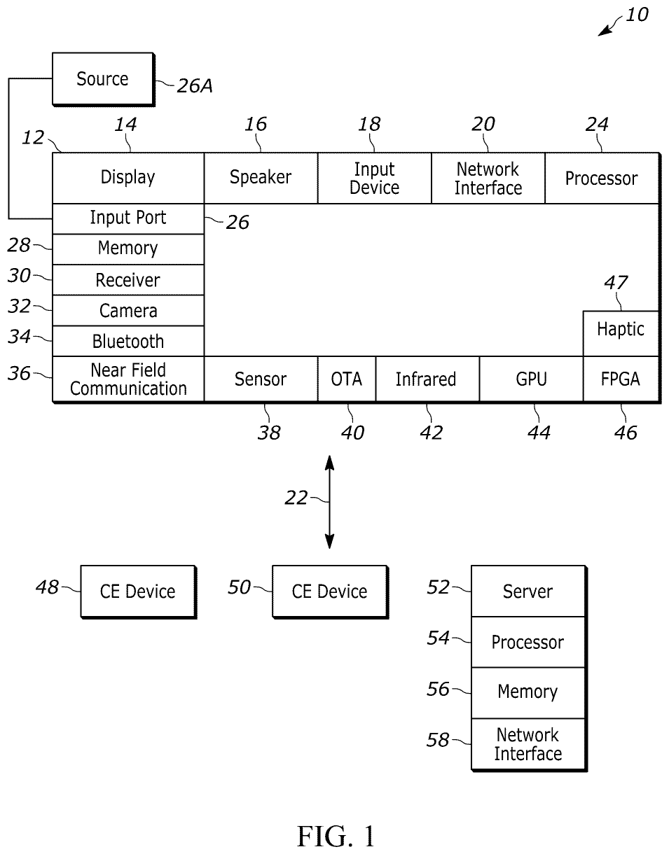

Referring now to FIG. 1, an example system 10 is shown, which may include one or more of the example devices mentioned above and described further below in accordance with present principles. The first of the example devices included in the system 10 is a consumer electronics (CE) device 12. The CE device 12 may be a computerized Internet enabled (“smart”) phone, a tablet computer, a laptop/notebook computer, a desktop computer, a head-mounted device (HMD) and/or headset such as smart glasses or AR or VR headset, another wearable computerized device, etc. Regardless, it is to be understood that the CE device 12 is configured to undertake present principles (e.g., communicate with other CE devices and servers to undertake present principles, execute the logic described herein, and perform other functions and/or operations described herein).

Accordingly, to undertake such principles the CE device 12 can be established by some, or all, of the components shown. For example, the CE device 12 can include one or more touch-enabled displays 14 that may be implemented by a high definition or ultra-high definition “4K” or higher flat screens. The touch-enabled display(s) 14 may include, for example, a capacitive or resistive touch sensing layer with a grid of electrodes for touch sensing consistent with present principles (e.g., to provide input to the GUIs discussed below).

The CE device 12 may also include an analog audio output port 15 to drive one or more external speakers or headphones, and may include one or more internal speakers 16 for outputting audio in accordance with present principles. The CE device 12 may also include at least one additional input device 18 such as one or more audio receiver/microphones, e.g., for detecting sound and entering audible commands to the CE device 12 to control the CE device 12. The example CE device 12 may also include one or more wired or wireless network interfaces 20 for communication over at least one network 22 such as the Internet, a WAN, a LAN, etc. under control of one or more processors of a processor system 24, such as a CPU or other processor mentioned above. Thus, the interface 20 may be, without limitation, a Wi-Fi transceiver and/or wireless telephony transceiver for communicating over a wireless cellular network (e.g., operated by Verizon, T-Mobile, or AT&T), both of which are examples of a wireless computer network interface. The network interface 20 may also be a wired or wireless modem or router or other suitable network interface.

It is to be understood that the processor system 24 may include one or more processors acting independently or in concert with each other to execute an algorithm, whether those processors are in one device or more than one device. The processor system 24 controls the CE device 12 to undertake present principles, including the other elements of the CE device 12 described herein such as controlling the display 14 to present images thereon and receiving input therefrom.

In addition to the foregoing, the CE device 12 may also include one or more input and/or output ports 26 such as a high-definition multimedia interface (HDMI) port or a universal serial bus (USB) port to physically connect to another CE device, and/or a headphone port to connect headphones to the CE device 12 for presentation of audio from the CE device 12 through the headphones. For example, the input port 26 may be connected wired or wirelessly to a cable or satellite source 26a of audio video content. Thus, the source 26a may be a separate or integrated set top box, or a satellite receiver. Or the source 26a may be a game console or disk player containing content.

The CE device 12 may further include one or more non-transitory computer memories/computer-readable storage media 28 such as disk-based or solid-state storage that are not transitory signals. In some cases, the media 28 may be embodied in the chassis/housing of the CE device 12 (e.g., as standalone devices) or as removable memory media or the below-described server(s).

Also, in some embodiments, the CE device 12 can include a position or location receiver such as but not limited to a cell phone transceiver, global positioning system (GPS) transceiver, and/or altimeter 30. This transceiver may therefore be configured to receive geographic position information from a satellite or cellphone base station (and/or determine an altitude at which the CE device 12 is disposed) and then provide the information to the processor system 24. However, it is to be understood that another suitable position receiver other than a GPS receiver, cell phone transceiver, and/or altimeter may be used consistent with present principles to determine the location of the CE device 12.

Continuing the description of the CE device 12, in some embodiments the CE device 12 may include one or more cameras 32 that may be thermal imaging cameras, digital cameras such as webcams, infrared (IR) sensors, and/or other types of cameras or other optical sensors integrated into the CE device 12 and controllable by the processor system 24 to gather pictures/images and/or video consistent with present principles. Also included on the CE device 12 may be a Bluetooth® transceiver 34 and/or other Near Field Communication (NFC) element 36 for communication with other devices using respective Bluetooth and/or NFC wireless technologies/communication standards. An example NFC element can be a radio frequency identification (RFID) element.

Further still, the CE device 12 may include one or more auxiliary sensors 38 that provide input to the processor system 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

Other sensor examples include a motion sensor such as an accelerometer, gyroscope, magnetometer, a speed and/or cadence sensor, an event-based sensor, a gesture sensor (e.g., for sensing gesture command), etc. In one specific example, the sensor 38 thus may be implemented as an inertial measurement unit (IMU) with motion sensors including individual accelerometers, gyroscopes, and magnetometers, and/or other components of that include a combination of accelerometers, gyroscopes, and magnetometers, to determine the location and orientation of the CE device 12 in three dimensions. A gyroscope consistent with present principles may sense and/or measure the orientation of the CE device 12 and provide related input to the processor system 24, an accelerometer consistent with present principles may sense acceleration and/or movement of the CE device 12 and provide related input to the processor system 24, and a magnetometer consistent with present principles may sense and/or measure directional movement of the CE device 12 and provide related input to the processor 122.

The CE device 12 may also include an over-the-air TV broadcast port 40 for receiving OTA TV broadcasts and providing the input to the processor system 24. In addition to the foregoing, it is noted that the CE device 12 may also include an IR transceiver 42 such as an IR data association (IRDA) device. A battery (not shown) may be provided for powering the CE device 12, as may a kinetic energy harvester that may turn kinetic energy into power to charge the battery and/or power the CE device 12. The CE device 12 may also be powered by an alternating current power supply. A graphics processing unit (GPU) 44 and field programmable gated array 46 also may be included.

One or more haptics/vibration generators 47 may also be provided for generating tactile signals/vibrations that can be sensed by a person holding or in contact with the device. The haptics generators 47 may thus vibrate all or part of the CE device 12 using an electric motor connected to an off-center and/or off-balanced weight via the motor's rotatable shaft so that the shaft may rotate under control of the motor (which in turn may be controlled by a processor such as the processor system 24) to create vibration of various frequencies and/or amplitudes as well as force simulations in various directions.

In addition to the CE device 12, the system 10 may include one or more other CE devices/types, which may include some or all of the components mentioned above in relation to the CE device 12. In one example, a second CE device 48 may be established by an Internet of things (IoT) device, a smartphone, a laptop computer, etc. A third CE device 50 is also shown in FIG. 1 and may include similar components as the other CE devices. Thus, in one example, the CE device 50 may be configured as a head-mounted display (HMD) that may include a heads-up transparent or non-transparent display for respectively presenting extended reality (XR) content such as AR content, VR, content, and/or mixed reality (MR) content. The XR content itself might include, as an example, one or more of the GUIs described below, presented stereoscopically. The HMD may be configured as a glasses-type display, or as goggle-type and/or VR-type display vended by various computer hardware manufacturers such as Apple, Oculus, Meta, etc.

In the example shown, only three CE devices are shown, it being understood that fewer or more devices may be used. A device herein may implement some or all of the components shown for the CE device 12. Any of the components shown in the following figures may incorporate some or all of the components shown in the case of the CE device 12.

Now in reference to the afore-mentioned at least one server 52, it includes at least one server processor/processor system 54 and at least one tangible computer readable storage medium 56 such as disk-based or solid-state storage. The server 52 also includes at least one network interface 58 that, under control of the server processor 54, allows for communication with other illustrated devices over the network 22 (e.g., the Internet), and indeed may facilitate communication between the server 52 and any other servers/client devices as described herein. Note that the network interface 58 may be, e.g., a wired or wireless modem or router, Wi-Fi or Ethernet transceiver, or other appropriate interface such as, e.g., a wireless telephony transceiver.

Accordingly, in some embodiments the server 52 may be an Internet server or an entire server “farm” of multiple services. If desired, the server 52 may include/perform “cloud” functions such that the devices of the system 10 may access a “cloud” environment via the server 52 in certain example embodiments. Additionally or alternatively, the server 52 may be implemented by one or more computers in the same room as the other devices shown, or nearby.

The components shown in the following figures may include some or all components shown herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

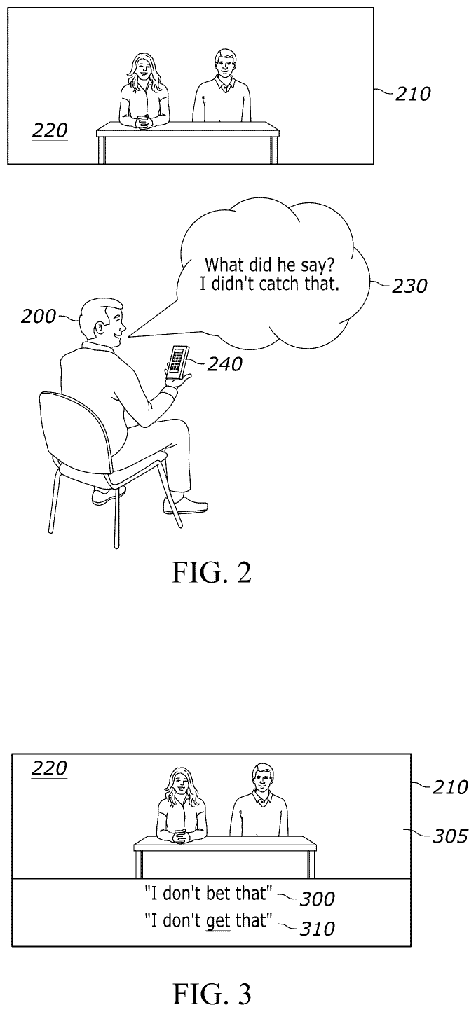

With the foregoing in mind, reference is now made to FIG. 2. Suppose a user 200 is watching audio video (AV) content as presented on a television 210. As such, audio of the AV content is being presented through the television's speakers while video 220 of the AV content is being presented on the television's video display. Or the AV content might be presented at another type of device as well, such as a laptop computer, smartphone, or head-mounted device (HMD) like smart glasses or an extended reality headset. In any case, also assume that the user 200 misses something that was said during a dialogue within the AV content. As such, the user might utter something like, “What did he say? I didn't catch that” as illustrated via the speech bubble 230 shown in FIG. 2.

While saying those words or shortly thereafter, the user might then select a predetermined replay button a remote control 240 to provide a command to the TV 210 to revert to playback of the AV content a preset number of time increments before a current playback position (e.g., revert twenty or thirty seconds back from the current playback position). Or the command may be a command to rewind linearly and continuously from a current playback position to the previous playback position rather than skipping back a predetermined number of time increments. Either way, the television 210 and/or a connected device controlling the television 210 may detect both the user's exclamation as well as the replay command to then undertake one or more additional actions beyond replaying the content itself. This may be done to help the user understand what was just said in the dialogue of the AV content.

FIG. 3 therefore illustrates one example action the device might take. Here, the AV content is replayed from a previous playback position that is twenty seconds prior to the current playback position from when the command was received. Additionally, FIG. 3 illustrates that two different types of text corresponding to the dialogue may be presented as part of a graphical user interface (GUI)/overlay 305 on top of the video 220. The first type is predetermined closed captioning text 300 sourced from metadata of the AV content. The metadata may have therefore been received from a broadcaster or other source of the AV content, whether that be an Internet streaming source, local storage location, or cloud storage location.

Additionally, a second type of closed captioning text 310 may also be presented. But in contrast to the text 300, the closed captioning text 310 has been determined by the device (and/or cloud server) dynamically on the fly. To get the text 310, the device may execute a speech recognition algorithm on the audio of the AV content that spans playback positions between the position to which playback was reverted and the first position (later in the playback timeline) at which playback was located immediately prior to receipt of the replay command. For example, the device may execute one or more speech-to-text algorithms on the audio to get a speech recognition result indicating the text 310. In some examples, that result alone may be presented as the closed captioning text 310.

However, in other examples the speech recognition result may be further processed for improved accuracy. As such, video from the same playback timespan may be passed through a lip reading model for the artificial intelligence (AI)-based model to infer a spoken word or words from the dialogue based on video from the AV content that shows one or more people/characters lips/mouth moving to speak. The speech recognition result and output from the lip reading model may then be provided as input to a large language model (LLM) that can then take the speech recognition result and the one or more words inferred by the lip reading model to itself infer a text string corresponding to most-probable speech/spoken words of the AV content as determined by the LLM. Thus, in some cases the speech recognition result from the speech recognition algorithm may remain unaltered after being processed by the LLM.

But in other instances, the LLM may alter the speech recognition result in relation to one or more ambiguous words from the audible speech in the AV content. The LLM may do so using an inferred (different) word from the lip reading model that the LLM determines was more likely to represent the audibly-spoken (ambiguous) word(s) from the AV content itself. For example, the LLM may infer as much based on the surrounding words of the speech recognition result and/or the closed captioning 300 for the played-back timespan, as well as potentially prior and forward playback position closed captioning as well. The altered text string from the LLM may then be output as the text 310. Also note that in examples, a speech recognition result for a given word may be returned as ambiguous based on the speech recognition result for that word being below a threshold confidence level (e.g., below seventy percent confidence).

The text 310 may then be presented by itself during replay of the AV content. Or the text 310 may be presented side-by-side with the text 300 so that the user can discern the differences between the texts 300, 310 to gain a better understanding of what was said in the AV content. The side-by-side presentation may be particularly helpful where source closed captioning (for the text 300) is being received from a TV broadcaster or other live content presentation source, but it contains errors and other shortcomings/misses due to being transcribed live on-the-fly, and so the text 310 may also be presented using AI to quickly provide (potentially) more accurate closed captioning to the user to discern what was said in the audio itself.

In addition to or in lieu of presenting one or more types of text as described above, the device may take other additional actions as well. For instance, the device may slow down playback of the AV content when reverting back to the previous playback position so that the user might more-clearly audibly discern what was said in the dialogue of the AV content. For example, the AV content may be played back at a speed slower than real-time (e.g., a slow-motion speed).

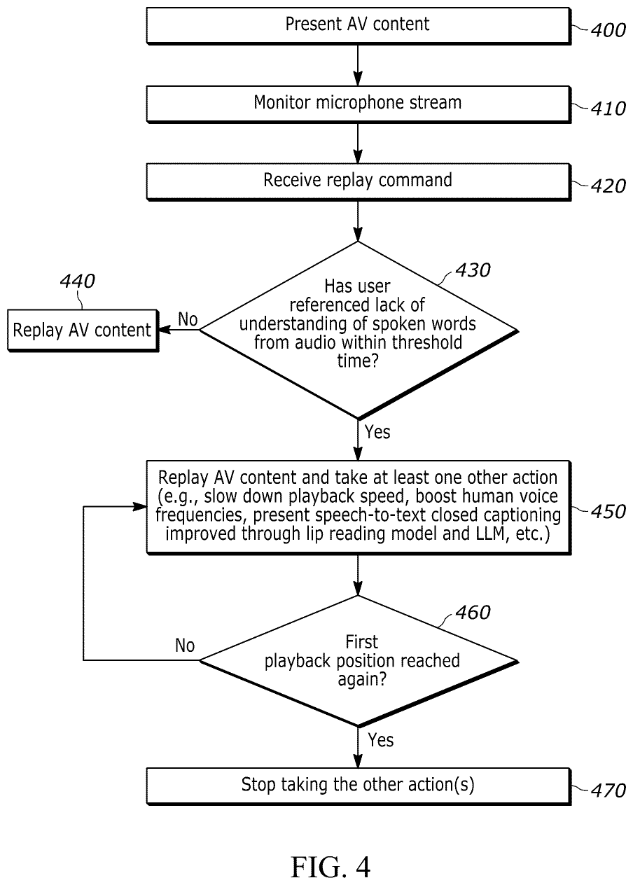

Additionally or alternatively, the device may boost the volume of the audio in one or more frequency ranges in which the average adult male and female voices fall, possibly while also reducing the volume of other audio (from the same timespan) in other frequency ranges that fall outside the one or more human frequency ranges. This too may be done so that the user might more-clearly audibly discern what was said in the dialogue of the AV content. The examples above will be discussed more below in relation to FIG. 4.

Accordingly, reference is now made to FIG. 4. This figure shows example logic that may be executed by an apparatus such as the CE device 12, a client device, and/or a coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Further note that while the logic of FIG. 4 is shown in flow chart format, other suitable logic may also be used.

Beginning at block 400, the apparatus may present audio video (AV) content at a client device such as a television, smartphone, laptop computer, extended reality headset, smart glasses, etc. The apparatus may do so based on user selection of the AV content, based on a power-on command to the television or set-top box, etc. From block 400 the logic may then proceed to block 410.

At bock 410 the apparatus may receive a real-time stream of live input from a microphone on the client device (or connected device) to monitor for verbal exclamations from a user/viewer of the AV content as the user watches the AV content. The logic may then proceed to block 420 where the apparatus may receive a replay command. The replay command may be provided via audible input, selection of a revert backwards selector on a media player GUI being used to present the AV content, selection of a revert back or linear rewind button on a remote control, selection of a dedicated button or other selector to perform the additional action(s), etc. Thus, note that in some instances, the replay command may be a command to revert to playback of the AV content a preset number of time increments before a current playback position (while skipping intervening portions), or to rewind the AV content linearly and continuously from a current playback position to the previous playback position. In either case, the logic may then proceed to decision diamond 430.

At diamond 430 the apparatus may determine whether the user has audibly (and even verbally) referenced a lack of understanding regarding spoken words from the audio of the AV content, as indicated in the input from the microphone that is received at block 410. To do so, the apparatus may execute one or more natural language processing algorithms using the input from the microphone. For instance, the apparatus may execute topic recognition, sentiment analysis, and/or natural language understanding to determine whether the user has verbally referenced a lack of understanding regarding the AV content's spoken words through a verbal expression (expression of a sentiment classified as confused or inquisitive, for example). Additionally, in some examples, non-verbal but still audible exclamations from the user may also be parsed to determine whether the non-verbal exclamations similarly indicate a lack of understanding through a non-verbal utterance of a sound inferred as indicating confusion, such as “huh?”

Also in some non-limiting examples, for an affirmative determination at diamond 430, the user input referencing the lack of understanding might be required to be received prior to but still within a threshold amount of time of receipt of the replay command itself. For example, the threshold amount of time may be ten seconds prior to receipt of the replay command such that the audible input referencing the lack of understanding being received ten seconds or less prior to receiving the replay command may result in an affirmative determination at diamond 430. This might be particularly useful in embodiments where pressing the same button on a remote control (or other user interface used to replay a portion of the AV content) can be used to provide two different commands both relating to replaying the AV content but under different circumstances. The first command may therefore be a command to replay the portion of the AV content without taking other additional actions as discussed herein, as might be received based on selection of the remote control button without the user also providing audible input that indicates the user's lack of understanding within the threshold amount of time prior to the button itself being pressed. The second command may be a command to replay the portion of the AV content and to take one or more additional actions consistent with present principles based on the additional trigger of the user expressing a lack of understanding about what was said within the threshold time. This technique may thus help the apparatus discriminate between the two different types of commands that might be provided using the same button on the remote control, helping to reduce false positives and incorrect command execution.

Accordingly, note that while a negative determination at diamond 430 may cause the logic to proceed to block 440 to execute the first command described in the paragraph immediately above, an affirmative determination at diamond 440 may instead cause the logic to proceed to block 450 to execute the second command described in the paragraph immediately above.

Accordingly, responsive to receipt of the replay command, at block 450 the apparatus may replay a portion of the AV content from a previous playback position and also take at least one additional action to aid the user's understanding of spoken words from the AV content. This might include presenting text corresponding to spoken words from audio of the AV content using one or more of the techniques described above in reference to FIG. 3. Therefore, in one particular example, the text corresponding to the spoken words may be established by predetermined closed captioning text from source metadata of the AV content. Additionally or alternatively, the apparatus may identify the text corresponding to the spoken words by executing speech recognition on the audio of the AV content and then executing a lip reading model using video of the AV content to adjust the text according to an output from the lip reading model. The output from the lip reading model may thus indicate a spoken word inferred by the lip reading model. An LLM may then be used to process the initial text from the speech recognition software and the output from the lip reading model to provide adjusted text. The adjusted text may include words from the speech recognition result itself as well as one or more replacement words from the LLM (as inferred by the lip reading model) such that the replacement word(s) may replace respective initial words from the speech recognition output.

In some specific instances, the speech recognition software may have different levels of confidence in the recognition of different words from the audio and, according to these examples, the lip reading model may then be executed to return outputs only for words for which the respective speech recognition result was below a threshold level of confidence (e.g., below seventy percent). This may help minimize processing time and save energy. Respective timestamps on the audio and video of the AV content may therefore be matched up for the apparatus to feed the lip reading model only short, separate video clips from the AV content where the corresponding audio from the same playback time(s) returned a speech recognition result(s) below the threshold level of confidence. The video clips themselves may be generated from the larger video of the AV content using video editing software, for example. The apparatus may thus execute the lip reading model to provide outputs for ambiguous words but not others, with the apparatus then replacing an original word from the speech recognition software with a lip reading-determined word. Or in other instances, the apparatus may provide, as input to an LLM, both the original word and the potential replacement words for further processing by the LLM.

Accordingly, it is to be understood that in some instances, the apparatus may replace certain words from the speech recognition result and output altered text to the user without using the LLM, such as when the lip reading model provides only one output as a potential recognition result for a given word (or only provides one output above a threshold level of confidence when plural recognition results are output). Then when two or more potential replacement words are output by the lip reading model for a given ambiguous word (or two potential replacement words above the threshold level of confidence specifically), the initial text from the speech recognition algorithm (e.g., speech-to-text) as well as the plural potential replacement words from the lip reading model may be provided to the LLM for further processing. This too may help reduce processing and save energy by reducing the number of times the LLM would be enlisted for assistance.

The LLM may then process the inputs themselves to infer an output/final text that the LLM has determined most-likely corresponds to the speaker's intent in the spoken words. The LLM may do so based on the context of surrounding words from the same speech as well as based on other data related to the AV content, including any other content metadata also provided to the LLM as input. The apparatus may then present the final text as closed captioning while concurrently replaying the same portions of the AV content itself that correspond to the spoken words indicated in the final text. In this way, the final text may be improved from the initial speech recognition result through the lip reading model and LLM.

Still in reference to block 450, note that in addition to or in lieu of presenting text(s) according to the description above, the apparatus may also slow down presentation of audio of the AV content from a real-time playback speed to a slower playback speed when replaying the AV content (e.g., slow down to a slow motion speed). The apparatus may also boost/increase the volume of the AV content's audio in frequencies that are in one or more human voice frequency ranges such that the volume is boosted from a first volume level at which audio in the one or more human voice frequency ranges was presented prior to receipt of the command to a second volume level that is higher than the first volume level. In various examples, the one or more human voice frequency ranges may include the average frequency range for an adult male human (e.g., 90 Hz to 155 Hz), the average frequency range for an adult female human (e.g., 165 Hz to 255 Hz), and/or the average frequency range for a child (e.g., 250 Hz to 400 Hz).

What's more, in certain specific non-limiting instances, the apparatus may not just boost human voice frequencies/ranges but also reduce the volume of audio in frequencies that are outside the one or more human voice frequency ranges (e.g., above/below the human voice frequency ranges). This too may help the user understand what was said in the AV content by reducing ambient/background noise and other audio from the AV content that would otherwise distract from discerning the spoken words as amplified through their own frequency boosting.

Also note in terms of block 450 that the replay that is executed at this step may be to begin playing the AV content again a preset number of time increments prior to a current playback position in the AV content. Or as another example, the apparatus may dynamically infer a previous playback position at which to resume playback based on that position being a playback position one or two seconds before (in the playback timeline) the words from the AV content would be played out that the user was identified as having trouble understanding. As such, topic segmentation and other natural language processing techniques may be used to identify the beginning of the speech subject to the user's confusion to then revert to a playback position a threshold time prior to that such as a same type of replay command may result in different playback replay amounts being used to replay AV content depending on the individual context involved.

From block 450 the logic of FIG. 4 may then proceed to decision diamond 460. At diamond 460 the apparatus may determine whether the first playback position has been reached again, with it being reiterated that the first playback position may be the position at which playback was occurring when the replay command was received at block 420. The first playback position may therefore be a later position on the playback timeline than the previous playback position to which playback was reverted. Thus, responsive to playback continuing again to the first location, the logic may proceed to block 470 where the apparatus may continue to playout the AV content at real-time speed but stop taking the one or more additional actions, such as boosting certain frequencies, slowing down presentation of the AV content, and/or presenting one or more versions of closed captioning text/subtitles. However, also note that responsive to a negative determination at diamond 460, the logic may revert back to block 450 to proceed again from there until an affirmative determination is made at diamond 460.

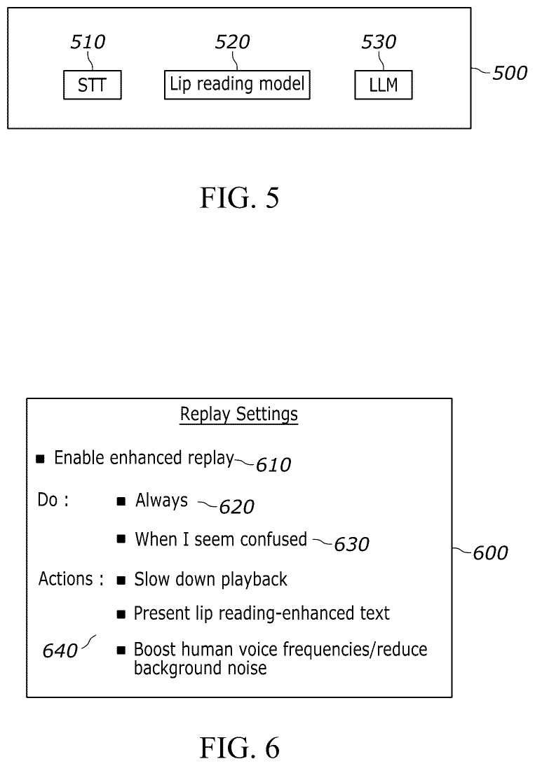

Continuing the detailed description in reference to FIG. 5, this figure shows example AI model architecture 500 that may be implemented consistent with present principles. Thus, the architecture 500 may include a speech-to-text model 510 (and/or other speech recognition module). The architecture 500 may also include a lip reading model 520 and LLM 530.

The lip reading model 520 may be a model such as LipSyncr. Other lip reading models may also be used, including machine learning-based models like transformer models, recurrent neural networks, convolutional neural networks, and others. The lip reading model may be trained on a dataset including video clips/samples of mouth movement and respective ground truth uttered words so that the model can learn to correctly infer different words based on different mouth/lip movements. Supervised learning may therefore be used, as may other deep learning techniques.

The LLM 530 may be established by an LLM such as GPT4 or Gemini. Additionally or alternatively, the LLM 530 may be a lighter LLM trained specifically for present principles. In either case, the LLM 530 may be trained on datasets of text strings and other AV content metadata as well as respective ground truth final text outputs so that the LLM can learn to infer a most-probable speech recognition result from the text string input and surrounding text/other metadata to then output a most-probable result as a final text string.

Accordingly, to operate the architecture 500 during deployment, an apparatus operating consistent with present principles may receive input from a microphone and identify speech from the input using the speech-to-text model 510, where the speech has been determined to indicate a user's lack of understanding about spoken words from audio of AV content as set forth above (or at least referenced spoken words if not necessarily indicating a lack of understanding about them per se). The apparatus may then execute the lip reading model 520 using video of the AV content for the apparatus/LLM 530 to adjust the initial text according to an output from the lip reading model (the output indicating a spoken word inferred by the lip reading model). Thus, the apparatus may either replace a word from the speech recognition result with a replacement word from the lip reading model 520 (e.g., if only one lip reading result above a threshold level of confidence is provided by the model 520), or may pass the outputs from the models 510, 520 to the LLM 530 for further processing for the LLM 530 to ultimately output a final text string to present as closed captioning/subtitles for the AV content.

Continuing the detailed description in reference to FIG. 6, this figure shows an example GUI 600 that may be presented on a display for an end-user to configure one or more settings of an apparatus or software application (“app”) to operate consistent with present principles. Each option discussed below may be selected by selecting the respective check box shown adjacent to that option, whether through cursor input, touch input, or another type of input.

Beginning first with the option 610, the option 610 may be selected a single time in a single instance to set or enable the device to, in multiple future playback instances, perform enhanced replay according to the principles set forth above with respect to FIGS. 2-5. Thus, selection of the option 610 may set or configure the device to take at least one additional action to help a user understand spoken words from AV content (an action beyond replaying a portion of the AV content itself).

The GUI 600 also include respective options 620, 630 for when the device is to take the additional action(s). The option 620 may be selected for the device to take the additional action(s) anytime a replay command is received, while the option 630 may be selected for the device to take the additional action(s) only when the user also indicates a lack of understanding about what was said in the AV content as described above (e.g., within a threshold amount of time of providing the replay command).

As also shown in FIG. 6, the GUI 600 may include respective options 640. Each option 640 may be selected to select a different particular type of additional action for the apparatus to take, such as slowing down the playback speed, presenting lip reading model-enhanced text, and boosting speech frequencies of the audio while reducing background noise frequencies.

Before concluding, it is to be understood that although a software application for undertaking present principles may be vended with a device, present principles apply in instances where such an application is downloaded from a server to a device over a network such as the Internet. Furthermore, present principles apply in instances where such an application is included on a computer readable storage medium that is vended and/or provided by itself, where the computer readable storage medium is not a transitory signal and/or a signal per se.

It may now be appreciated that present principles provide, among other technical improvements, improved computer-based user interfaces that increase the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein.

1. An apparatus, comprising:
a processor system; and
storage accessible to the processor system and comprising instructions executable by the processor system to:
present audio video (AV) content at a device;
receive a command to replay a portion of the AV content; and
responsive to receipt of the command, replay the portion of the AV content from a previous playback position and also take at least one other action to aid a user's understanding of spoken words from the AV content, wherein the at least one other action comprises the use of a deep neural network to use sound patterns and neural network processing to replace incoming sound with processed outgoing sound to enhance speech clarity.

2. The apparatus of claim 1, wherein the at least one other action comprises presenting text corresponding to spoken words from audio of the AV content.

3. The apparatus of claim 2, wherein the text corresponding to the spoken words is established by closed captioning text from metadata of the AV content.

4. The apparatus of claim 2, wherein the instructions are executable to:
identify the text corresponding to the spoken words by executing speech recognition on the audio of the AV content.

5. An apparatus, comprising:
a processor system; and
storage accessible to the processor system and comprising instructions executable by the processor system to:
present audio video (AV) content at a device;
receive a command to replay a portion of the AV content; and
responsive to receipt of the command, replay the portion of the AV content from a previous playback position and also take at least one other action to aid a user's understanding of spoken words from the AV content, wherein the at least one other action comprises presenting text corresponding to spoken words from audio of the AV content and the instructions are executable to:
execute a lip reading model using video of the AV content to adjust the text according to an output from the lip reading model, the output indicating a spoken word inferred by the lip reading model.

6. The apparatus of claim 1, wherein the at least one other action comprises slowing down presentation of audio of the AV content from a real-time playback speed to a slower playback speed.

7. The apparatus of claim 1, wherein the at least one other action comprises one of: boosting the volume of audio of the AV content in frequencies that are in one or more human voice frequency ranges, the boosting being from a first volume level at which audio in the one or more human voice frequency ranges was presented prior to receipt of the command to a second volume level that is higher than the first volume level, reducing the volume of audio in frequencies of the audio that are outside the one or more human voice frequency ranges

8. (canceled)

9. An apparatus, comprising:
a processor system; and
storage accessible to the processor system and comprising instructions executable by the processor system to:
present audio video (AV) content at a device;
receive a command to replay a portion of the AV content; and
responsive to receipt of the command, replay the portion of the AV content from a previous playback position and also take at least one other action to aid a user's understanding of spoken words from the AV content, wherein the AV content is played back from a first position different from the previous position, and wherein the instructions are executable to:
in the same presentation instance, responsive to reaching the first position again during playback of the AV content, stop taking the at least one other action in relation to presentation of the AV content from the previous playback position.

10. A method, comprising:
presenting audio video (AV) content at a device;
receiving a command to replay a portion of the AV content; and
responsive to receiving the command, replaying the portion of the AV content from a previous playback position and also taking at least one other action related to presentation of the AV content from the previous playback position, wherein the command is a command to revert to playback of the AV content a preset number of time increments before a current playback position.

11. The method of claim 10, comprising:
receiving input from a microphone;
based on the input, identifying speech, from a user, indicating a lack of understanding about spoken words from audio of the AV content; and
based on identifying the speech, taking the at least one other action related to presentation of the AV content from the previous playback position.

12. (canceled)

13. The method of claim 10, wherein the at least one other action comprises presenting text corresponding to spoken words from audio of the AV content.

14. A method, comprising:
presenting audio video (AV) content at a device;
receiving a command to replay a portion of the AV content;
responsive to receiving the command, replaying the portion of the AV content from a previous playback position and also taking at least one other action related to presentation of the AV content from the previous playback position;
identifying text corresponding to spoken words in the AV content by executing speech recognition on audio of the AV content; and
executing a lip reading model using video of the AV content to adjust the text according to an output from the lip reading model, the output indicating a spoken word inferred by the lip reading model.

15. The method of claim 10, wherein the at least one other action comprises slowing down presentation of the AV content from a real-time playback speed to a slower playback speed.

16. The method of claim 10, wherein the at least one other action comprises boosting the volume of audio of the AV content in frequencies that are in one or more human voice frequency ranges, the boosting being from a first volume level at which audio in the one or more human voice frequency ranges was presented prior to receipt of the command to a second volume level that is higher than the first volume level.

17. The method of claim 16, wherein the one or more human voice frequency ranges comprises a frequency range comprising one of: 90 Hz to 155 Hz, 165 Hz to 255 Hz.

18. A method, comprising:
presenting audio video (AV) content at a device;
receiving a command to replay a portion of the AV content; and
responsive to receiving the command, replaying the portion of the AV content from a previous playback position and also taking at least one other action related to presentation of the AV content from the previous playback position wherein the at least one other action comprises the use of neural network processing to separate speech from background noise, and to output the processed speech.

19. At least one computer readable storage medium (CRSM) that is not a transitory signal, the at least one CRSM comprising instructions executable by a processor system to:
present audio video (AV) content at a device;
receive a command to replay a portion of the AV content; and
responsive to receipt of the command, replay the portion of the AV content from a previous playback position and also take at least one other action related to presentation of the AV content from the previous playback position, wherein the at least one other action comprises adjusting text identified using a speech-to-text algorithm, the text adjusted based on an output from a lip reading model that processed video of the AV content to provide the output; and
presenting the adjusted text on a display during the replay of the portion of the AV content from the previous playback position.

20. (canceled)
